(19) United States
(12) Patent Application Publication
(10) Pub. No.: US 2024/0363933 A1
(43) Pub. Date: Oct. 31, 2024

(54) BATTERY CELLS INCLUDING RESILIENT POUCHES

(71) Applicant: Solid Power Operating, Inc., Louisville, CO (US)

(72) Inventors: Clint R. Bickmore, Louisville, CO (US); Nathan Dunlap, Golden, CO (US); Nathaniel P. Crane, Louisville, CO (US); Joshua Buettner-Garrett, Arvada, CO (US); Benjamin A. Carlson, St. Paul, MN (US); Brandon Kelly, Longmont, CO (US)

(21) Appl. No.: 18/647,900

(22) Filed: Apr. 26, 2024

Related U.S. Application Data
(60) Provisional application No. 63/462,196, filed on Apr. 26, 2023.

(51) Int. Cl. H01M 50/129; H01M 50/105; H01M 50/119; H01M 50/121; H01M 50/124; H01M 50/131; H01M 50/178; H01M 50/186; H01M 50/193

(52) U.S. Cl. CPC H01M 50/129; H01M 50/105; H01M 50/119; H01M 50/121; H01M 50/1243; H01M 50/131; H01M 50/178; H01M 50/186; H01M 50/193

(57) ABSTRACT

A resilient battery cell is provided that includes an electrode and an electrolyte hermetically sealed within a pouch. The pouch includes layers of heat-resistant and resilient materials coupled together by a thermoplastic seal. A conductive tab electrically coupled to the electrode and for electrically coupling of the battery cell to other cells and/or a battery terminal extends through and is hermetically sealed by the sealant. The battery cell may further include supplemental layers external the pouch for providing structural integrity, a vapor barrier, improved fire safety, and other benefits.

### CROSS-REFERENCE TO RELATED APPLICATION

This application is related to and claims priority under 35 U.S.C. § 119 (e) to U.S. Patent Application No. 63/462,196 filed Apr. 26, 2023, titled “Battery Cells Including Resilient Pouches,” the entire contents of which is incorporated herein by reference for all purposes.

### FIELD

This disclosure relates to the field of electrochemical batteries and, more particularly, to pouches for use in a variety of battery types and batteries integrating such pouches.

### BACKGROUND AND INTRODUCTION

The proliferation of battery powered devices including mobile computing devices and smart phones, hybrid/electric automobiles, and Internet-of-Things devices has driven a substantial need for improvements in battery technologies. Solid-state battery technologies represent opportunities to improve on a host of areas that are important for commercial application of batteries including reliability, capacity (mAh), thermal characteristics, safety, cycle life, and recharge performance, among others.

A solid-state battery includes a solid electrolyte coupled to an anode and a cathode, forming an electrochemical cell. One key difference between a conventional liquid electrolyte battery and a solid-state battery is the use of a solid electrolyte. The electrochemical cell is often disposed within a pouch, bag, or similar structure to hermetically seal and protect the electrochemical cell and internal cell components. The anode and cathode may extend from the pouch or be electrically coupled to respective tabs or terminals that extend from the pouch to facilitate electrical connection to the electrochemical cell. A given battery may include one or more discrete cells with batteries having more and/or larger cells generally providing greater storage capacity than batteries having fewer/smaller cells.

While solid-state batteries are generally considered safer than liquid-based batteries due to an inherently lower risk of overheating and shorting, the substantial amount of energy potentially stored in a solid-state battery still causes safety to be a top priority for manufacturers and users. Physical/mechanical damage, electrical shorting, overcharging, and other similar events can still result in failure of a solid-state battery. Such safety concerns are particularly acute when designers and engineers need to account for likely damage to the battery (e.g., automotive applications given the likelihood that a battery-powered vehicle will be involved in a collision) or potential use of a battery in critical systems or hazardous environments.

These and other issues are addressed by various aspects of the present disclosure discussed in detail below.

### SUMMARY

In one aspect of this disclosure, a battery is provided that includes a cell comprising a first electrode layer, a second electrode layer, and an electrolyte layer and a pouch having an internal volume. The pouch includes a first layer including a first heat-resistant material and forming a first inner surface of the pouch, a second layer including a second heat-resistant material and forming a second inner surface of the pouch, and a sealant disposed between the first layer and the second layer. The battery further includes a conductive tab extending through the sealant and electrically coupled to the first electrode layer. The sealant hermetically seals against each of the first layer of the pouch, the second layer of the pouch, and the conductive tab, thereby hermetically sealing the cell within the internal volume.

In another aspect of this disclosure, a battery cell is provided that includes a first electrode, a second electrode, an electrolyte, a conductive tab electrically coupled to the first electrode, and a coating layer. The coating layer encapsulates the first electrode, the second electrode, and the electrolyte and the conductive tab extends through the coating layer, such that the coating layer forms a hermetic seal around the electrode and the electrolyte and about the conductive tab.

In yet another aspect of this disclosure, a method for manufacturing a battery cell is provided, the method includes disposing an electrode and an electrolyte within an internal volume defined by a first pouch layer, a second pouch layer, and a sealant layer, where the first pouch layer includes a first heat-resistant material and the second pouch layer includes a second heat-resistant material and a conductive tab electrically coupled to extends out of the internal volume. The method further includes forming a seal between the first pouch layer and the second pouch layer and around the conductive tab by heating the sealant layer to a melting point to hermetically seal the internal volume.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1A is an elevation view of a battery cell according to a first implementation of this disclosure.

FIG. 1B is a cross-sectional view of the battery cell of FIG. 1A.

FIG. 2 is across-sectional view of an alternative battery cell according to this disclosure including supplemental layers extending around a primary internal cell structure.

FIG. 3 is a cross-sectional view of another alternative battery cell according to this disclosure including supplemental layers and, more specifically supplemental layers arranged to include a void within which material, such as a fire suppressant, may be disposed.

FIG. 4 is a cross-sectional view of a battery cell including a coated inner assembly, the inner assembly including an electrode and an electrolyte.

FIG. 5 is a flow chart illustrating a method for manufacturing a battery cell in accordance with this disclosure.

FIG. 6A to FIG. 6G illustrates an example battery cell at various points in an example manufacturing process.

FIG. 7 is a cross-sectional view of another battery cell according to this disclosure including a preformed shell.

### DETAILED DESCRIPTION

Aspects of this disclosure are directed to batteries with various features for improved resiliency, including improved thermal and mechanical performance. Among other applications, the batteries described in this disclosure may be well-suited for use in automotive applications. While various aspects of the present disclosure are discussed with reference to solid-state batteries, it should be recognized that concepts may apply to other battery formats including those with liquid electrolyte. Additionally, while aspects of the disclosure may be particularly suited for automotive applications, the various aspects are by no means limited to the same.

The term “battery” or “battery cell” in the art and herein can be used in various ways and may refer to an individual cell having an anode and cathode separated by an electrolyte, which may be a solid electrolyte, as well as a collection of such cells connected in various arrangements. A solid-state electrolyte cell may include more than one anode and cathode, separated by solid electrolyte layers, and may be encased within a flexible “pouch” that accommodates the expansion and contraction of the anode(s) and cathode(s) as the cell charges and discharges. Although many examples are discussed herein as applicable to a battery or a discrete cell, it should be appreciated that the systems and methods described may apply to many different types of batteries, battery chemistries, and may range from an individual cell to batteries involving different possible interconnections of cells such as cells coupled in parallel, series, and parallel and series. The electrodes (e.g., the cathodes and anodes) are in electrical communication with terminals or tabs that extend through the pouch to enable electrical coupling of the battery to a battery terminal and/or to a circuit connecting multiple battery cells. The various implementations discussed herein may also apply to different structural battery arrangements including pouch cells and other cell structures that may accommodate size changes in the electrodes.

Conventional pouch structures rely on a tri-layer Polypropylene-Aluminum-Nylon (or “P-A-N”) construction. For example, certain conventional pouch cells are formed by positioning two P-A-N stacks on opposite sides of the cell with the polypropylene layers as the innermost layer of the stack, and the nylon layer outwardly facing. Pressure and heat are subsequently applied to this sandwiched configuration to fuse the polypropylene layers together around the internal cell components, thereby sealing the internal cell components. The other layers of the pouch may be coupled to each other by an adhesive.

Such conventional pouch constructions are known and reliable but may encounter issues should the battery cell temperature exceed the melting/softening point of polypropylene. While risk of overheating is generally lower in solid-state batteries than in liquid-based batteries, overheating can still occur. Moreover, in a variety of applications, batteries are pressed to produce greater discharge currents or pushed to charge at higher charge currents, which may produce more heat. Thus, in various possible situations, the battery may exceed the melting/softening temperature of the innermost polypropylene layer, damaging the polypropylene and potentially compromising the seal surrounding the inner cell components. The seal may also be compromised due to mechanical damage, such as puncturing or tearing of the P-A-N stack. Some existing or emerging automobile requirements, for example, may involve testing battery packs in various crash scenarios where punctures or other unintended ingress into a pack and associated batteries are envisioned.

When the seal between the polypropylene layers becomes compromised, air/moisture can contact the internal cell structure, leading to a possible thermal event as the air/moisture reacts with the various materials used within the battery. Such a thermal event can further damage the polypropylene layers, resulting in further compromise of the seal. In certain situations, thermal events can cause temperatures to rise to the point of the nylon and polypropylene melting or combusting leading to a catastrophic failure of the battery. When such a failure occurs in conventional batteries, damage can quickly spread to other discrete batteries within a battery pack, other battery components, and any device or equipment within which the battery is installed.

Thermal and mechanical degradation of the innermost polypropylene layer can also result in localized damage or disintegration of the polypropylene layer. In certain cases, such disintegration can expose the aluminum layer of the P-A-N stack and allow the aluminum layer to contact the electrodes/conductive tabs of the battery. When the aluminum layer contacts both electrodes, it can short the battery, resulting in rapid discharge, rapid temperature increase, and a potential thermal event causing failure of the battery, and battery-powered device/equipment.

To address the issues noted above, among others, batteries according to this disclosure include a layer of high-temperature film encapsulating an inner assembly including an electrode and an electrolyte with the encapsulating film being coupled/closed with a high-temperature sealant. In one example implementation, a battery is formed by disposing the inner assembly between opposing sheets, each of which includes the high-temperature film. The opposing sheets are bonded by a sealant encapsulating the internal cells in the high-temperature film. The sealant also extends around any conductive tabs coupled to and extending from electrodes of the inner assembly, sealing and encapsulating the tabs extending from the internal cell volume. In one particular implementation, the sealant layer may be three-dimensional printed to a similar shape as the battery cell disposed within the pouch. The result is a battery having a hermetically sealed inner volume in which the innermost layer of the battery is formed from a heat-resistant material. In one specific and non-limiting example, a sheet includes, in addition to possibly other layers, a single layer of a polyimide polymer such as Kapton® and the sealant may be a thermoplastic, such as a thermoplastic urethane (TPU). Such a sealant layer may be formed to be similar in shape to the battery cell within the pouch. For example, a rectangular sealant layer may be disposed on a bottom layer of the pouch within which a rectangular cell may be located. In another example, a circular sealant layer may be disposed on the bottom layer of the pouch to accommodate a cylindrical battery cell. Other battery cell shapes and sealant layer shapes are contemplated.

This disclosure also contemplates that the battery described above may be enhanced by one or more additional layers of material disposed around the heat-resistant material. For example, a sheet, which may be formed into a pouch, may include additional layers formed from thermoplastic (e.g., polypropylene or nylon) or metallic (e.g., aluminum foil or metallized film) materials. Such a multilayer sheet, in conjunction with the heat-resistant layer, may define a pouch battery with additional structural/mechanical strength, provide an improved vapor barrier between the inner assembly and external environment, and/or provide the battery cell with a specific shape and other enhancements.

This disclosure also describes implementations of battery cells where the encapsulating pouch defines functional voids around the inner assembly. In certain implementations, the voids may contain safety-related materials, such as fire suppressants/retardants or puncture-resistant polymers for inhibiting or reducing damage caused to a given cell. For example, a pouch may include a void containing a fire suppressant/retardant such that if the cell becomes compromised (e.g., due to mechanical damage or overheating), the fire suppressant/retardant will enter the internal volume of the cell to protect against ignition, further overheating, or similar conditions. In certain implementations, an innermost layer of the encapsulating pouch and a supplemental layer disposed externally adjacent to the innermost layer may define the void. In other implementations, a pair of supplemental layers external and that excludes the innermost layer may define the void.

This disclosure also contemplates battery cells formed by applying an insulating and hermetically sealing coating around the inner assembly. For example, the inner assembly may be dip coated with TPU or vapor coated using parylene or other conformal coating. Such implementations may be further enhanced by supplemental layers of material disposed around or otherwise containing the coated cell internals.

The foregoing aspects of this disclosure, among others, will now be discussed in further detail with reference to the accompanying figures.

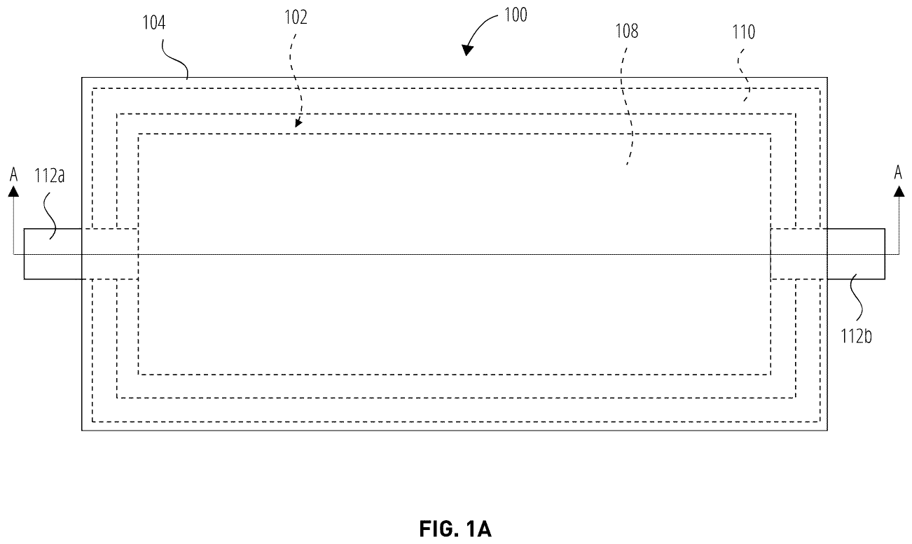

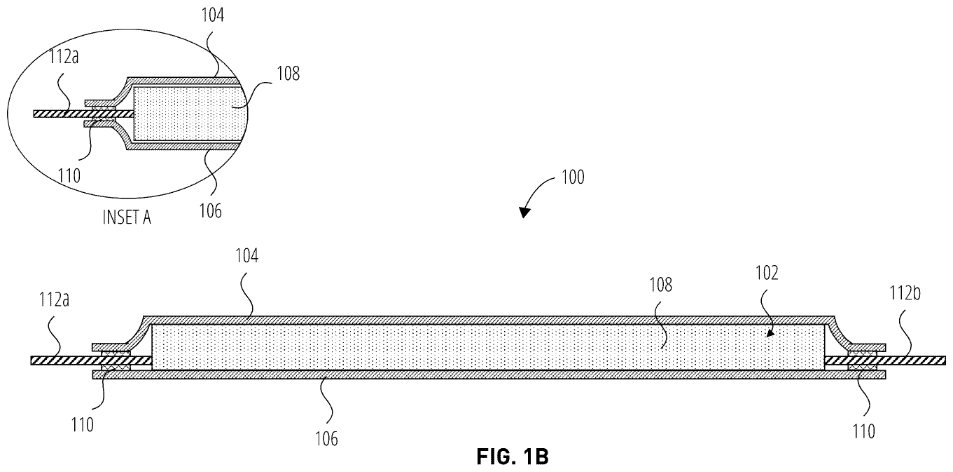

FIG. 1A is an elevation view of an implementation of a battery cell 100 according to this disclosure. FIG. 1B is a section view of battery cell 100 taken along line A-A, shown in FIG. 1A.

Battery cell 100 includes a first layer and a second layer, which correspond to an upper layer 104 and a lower layer 106 in FIG. 1. The terms “upper” and “lower” are used for clarity in light of the presentation and orientation of battery cell 100 in FIG. 1B (and similar layers in subsequent figures) and are not intended to connote any specific limitations on the orientation or arrangement of battery cell 100 and its components. As shown in FIG. 1B, battery cell 100 further includes a sealant 110 extending between upper layer 104 and lower layer 106 and forming a closed perimeter about an inner assembly 108 and with sealant 110 having a thickness that accommodates the thickness of inner assembly 108. Collectively, upper layer 104, lower layer 106, and sealant 110 define an internal volume 102. When battery cell 100 is fully assembled, internal volume 102 is hermetically sealed and contains inner assembly 108.

Inner assembly 108 generally includes electrolyte and electrodes. For example, in certain implementations, inner assembly 108 may include an anode layer and a cathode layer and the electrolyte may include a solid-state electrolyte separator between the anode layer and the cathode layer. In certain implementations, inner assembly 108 may include multiple electrode layers with interspersed electrolyte layers. Conductive tabs or similar structures are electrically coupled to the electrode layers, typically through respective current collectors, to permit electrical connection to the battery and through which the battery provides power to a load and is charged. Battery cell 100, for example, includes a first conductive tab 112a and a second conductive tab 112b, each of which is electrically coupled, as noted above typically through a current collector layer, to a respective electrode of inner assembly 108. When fully assembled, each of first conductive tab 112a and second conductive tab 112b extend through sealant 110 such that sealant 110 extends and hermetically seals around each of first conductive tab 112a and second conductive tab 112b. In a battery with multiple cells, one conductive tab may be coupled with several anode layers, and the other conductive tab coupled with several cathode layers.

The embodiments illustrated in this disclosure generally depict battery cells in which a first conductive tab extends from a first side of a battery cell and a second conductive tab extends from a second side of the battery opposite the first side. Such an arrangement is intended to be illustrative only and other conductive tab configurations are contemplated and within the scope of this disclosure. For example, in one alternative implementation, first conductive tab 112a and second conductive tab 112b may extend from the same side of battery cell 100 or extend from perpendicular sides of battery cell 100. More generally, implementations of this disclosure are not limited to any specific configuration of conductive tabs and the size, shape, position, etc., of the conductive tabs can be readily modified to accommodate a specific application and battery cell design.

In one implementation, each of upper layer 104 and lower layer 106 are formed from a resilient material, such as a heat-resistant material. For example, the upper layer 104 may be formed from a first heat-resistant material and the lower layer 106 may be formed from a second heat resistant material. The first heat-resistant material and the second heat-resistant material may be the same or substantially similar materials or, in some cases, may be different materials. In one implementation, one or both of the first heat-resistant material and the second heat-resistant material may be a polyimide polymer, such as, but not limited to Kapton®. In other implementations, one or both of the first heat-resistant material and the second heat-resistant material may be a polyamide polymer, such as, but not limited to nylon. In other implementations, one or both of the first heat-resistant material and the second heat-resistant material may be a fluoropolymer, such as perfluoroalkoxy (PFA). In still other implementations, one or both of the first heat-resistant material and the second heat-resistant material may be formed from any suitable material excluding polypropylene.

As noted above, the upper layer and lower layer of the finished pouch may be formed from discrete sheets. Alternatively, the upper layer and lower layer may be formed from a single sheet folded over on itself over the cell structure to be encapsulated, in which case sealant may only be applied along three of four edges, with the fourth edge being the area where the sheet is folded. In such a situation, even if the sheet includes additional layers, the inner layer adjacent the cell structure may be the heat-resistant material layer.

In at least certain implementations, the material of upper layer 104 and lower layer 106 may instead or additionally be selected based on one or more physical properties, such as the melting point of the material. For example, and without limitation, the first heat-resistant material and the second heat resistant material may be selected to have a melting point of at least about 160° C.

Sealant 110 may similarly be selected from a range of suitable materials. As described below in further detail, sealant 110 is generally formed by melting and fusing a sealant bead disposed on upper layer 104 with a corresponding sealant bead disposed on lower layer 106. In some alternatives, one or more sealant beads, or lines, may be disposed on only the upper or lower layer. The melting and fusing forms sealant 110 and hermetically seals internal volume 102. While various materials may be used to achieve these results, in at least certain implementations sealant 110 may be formed from a thermoplastic (e.g., thermoplastic polyurethane (TPU)), a thermoplastic elastomer, or a fluoropolymer (e.g., PFA).

In addition to being heat-resistant, the material and/or size of each of upper layer 104 and lower layer 106 may be selected to permit expansion of inner assembly 108. More specifically, as inner assembly 108 is charged and discharged, the electrodes of inner assembly 108 will swell and shrink, respectively. Accordingly, in certain implementations, upper layer 104, lower layer 106 and sealant 110 may be sized to accommodate expansion and contraction of inner assembly 108 without inducing substantial stress on upper layer 104, lower layer 106, or sealant 110.

While FIG. 1A and FIG. 1B illustrate an inner assembly 108 of battery cell 100 as having a substantially prismatic shape (e.g., a rectangular prismatic shape or other solid shape bounded on its sides by planar faces), implementations of this disclose are not limited to any specific form factor of inner assembly 108 or battery cell 100. So, for example, in addition to the prismatic implementations illustrated in the figures and described throughout this disclosure, inner assembly 108 and the corresponding pouch may have a variety of possible non-prismatic shapes.

The specific implementation illustrated in FIG. 1B shows lower layer 106 as being substantially planar with upper layer 104 partially conforming around inner assembly 108 and coupled to lower layer 106 by sealant 110. In other implementations, lower layer 106 may also partially conform around inner assembly 108. In such configurations, upper layer 104 may also partially conform around inner assembly 108, may be substantially planar, or be otherwise disposed to contain inner assembly 108. For example, Inset A of FIG. 1B illustrates an alternative configuration of battery cell 100 in which each of lower layer 106 and upper layer 104 partially conform around inner assembly 108. Also, the various implementations of this disclosure are generally illustrated with conductive tabs (e.g., first conductive tab 112a) as being offset toward a lower layer (e.g., lower layer 106). However, implementations of this disclosure are not limited to any specific location of the conductive tabs relative to inner assembly 108 and other components of battery cell 100. For example, Inset A of FIG. 1B illustrates and example implementation in which first conductive tab 112a extends from an approximate mid-line of inner assembly 108.

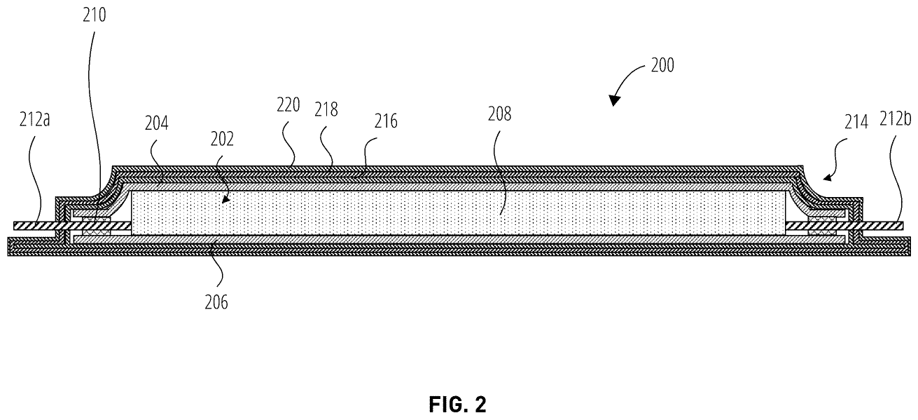

FIG. 2 is a cross sectional view of a second battery cell 200 according to this disclosure. Similar to battery cell 100 shown in FIG. 1A and FIG. 1B, battery cell 200 includes an upper layer 204, a lower layer 206, and a sealant 210 extending between upper layer 204 and lower layer 206. Collectively, upper layer 204, lower layer 206, and scalant 210 define an internal volume 202 that hermetically seals and contains an inner assembly 208. Similar to inner assembly 108 of battery cell 100, inner assembly 208 of battery cell 200 includes at least one electrode and at least one electrolyte, but may include multiple electrolytes layered with multiple electrodes (not shown), the latter of which may be coupled to conductive tabs to facilitate electrical connection to inner assembly 208. For example, FIG. 2 includes a first conductive tab 212a and a second conductive tab 212b coupled to inner assembly 208. As shown, each of first conductive tab 212a and second conductive tab 212b extends through sealant 210 such that sealant 210 hermetically seals around first conductive tab 212a and second conductive tab 212b.

In contrast to battery cell 100, which has a single layer pouch design, battery cell 200 further includes supplemental layers 214. Although the number and type of layers included in supplemental layers 214 may vary, supplemental layers 214 of the specific implementation shown in FIG. 2 include three layers and, more specifically (from internal to external) a first thermoplastic layer 216, a metallic layer 218, and second thermoplastic layer 220. Stated differently, first thermoplastic layer 216 is outwardly adjacent and extends around upper layer 204 and lower layer 206, metallic layer 218 is outwardly adjacent first thermoplastic layer 216, and second thermoplastic layer 220 is outwardly adjacent metallic layer 218.

Supplemental layers 214 may optionally be hermetically sealed; however, in light of internal volume 202 being hermetically sealed, hermetic sealing of supplemental layers 214 may not be strictly necessary in certain designs and applications. As discussed below in further details, supplemental layers 214 may be formed using various techniques. For example, supplemental layers 214 may be preformed as a pouch or pocket within which an internal pouch assembly including inner assembly 208, lower layer 206, upper layer 204, and sealant 210 is disposed prior to closing the pouch/pocket (e.g., using an adhesive, heat, or other process). In other implementations, supplemental layers 214 may be formed by disposing the internal pouch assembly between two sets of sheets (e.g., which may be discrete sections of sheet or sheets applied from respective rollers) and joining the sets of sheets using heat, an adhesive, or another suitable technique. Notably, this latter approach of forming the supplemental layers 214 may, in certain implementations, be performed simultaneously with forming of sealant 210 and hermetically sealing internal volume 202. For example, during assembly, sufficient heat and pressure may be applied to not only form sealant 210 and bond sealant 210 to upper layer 204 and lower layer 206, but to also seal or otherwise bond supplemental layers 214 as necessary. This disclosure also contemplates that supplemental layers 214 may be applied or formed around the internal pouch assembly as individual sheets, as multi-layer sheets, or a combination of single- and multilayer sheets. In the case of multilayer sheets, a given multilayer sheet may include all or a subset of supplemental layers 214 and a given assembly may include applying more than one multilayer sheet.

In general, supplemental layers 214 may be selected to provide additional resiliency and/or additional chemical or physical properties to battery cell 200. For example, in certain implementations, one or more of supplemental layers 214 (e.g., first thermoplastic layer 216) may be selected to provide a vapor barrier. As another example, one or more of supplemental layers 214 (e.g., metallic layer 218 or second thermoplastic layer 220) may be selected to provide structural integrity, mechanical strength/resiliency, shape, protection from external dirt and moisture, shock absorbency, or similar properties and enhancements to battery cell 200.

Material of a given supplemental layer may vary and may be based on the particular function of the layer. By way of non-limiting example, first thermoplastic layer 216 and second thermoplastic layer 220 may be formed from a thermoplastic such as polypropylene or nylon. Again, by way of non-limiting example, metallic layer 218 may be formed from a metal, such as aluminum, and may be provided from a sheet of aluminum foil.

The supplemental layers discussed above are intended merely as examples. So, for example, while the preceding discussion focused primarily on an implementation in which the supplemental layers included three layers (e.g., a metallic layer between two thermoplastic layers), this disclosure contemplates that supplemental layers may more generally include one or more layers. Similarly, the composition of each layer within the supplemental layers may vary. In certain implementations, the innermost layer of the supplemental layers will preferably be formed from a non-conductive/insulating material (e.g., a thermoplastic) to avoid shorting the conductive tabs of the battery cell; however, this disclosure contemplates that insulative coatings or similar treatments may be applied to the conductive tabs, at least in part, to enable the use of conductive materials in the innermost supplemental layer. Accordingly, this disclosure contemplates that supplemental layers may be used in any suitable arrangement or configuration and may be formed using any suitable material to improve or otherwise enhance properties and performance of battery cells.

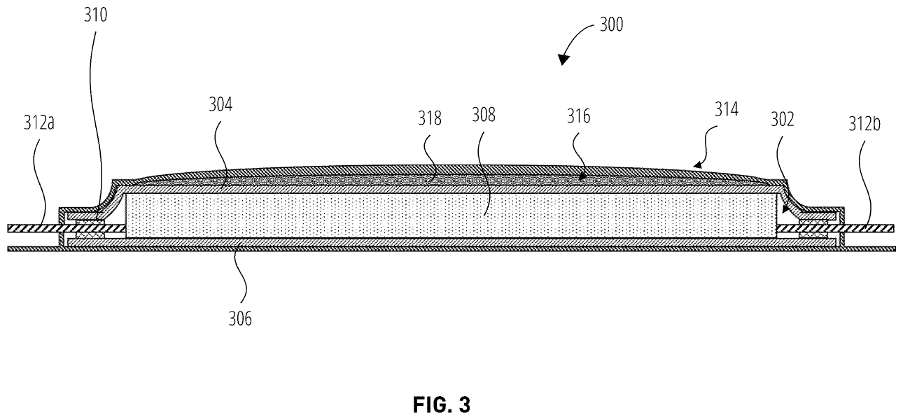

FIG. 3 is a cross sectional view of a third battery cell 300 according to this disclosure. Similar to battery cell 100 shown in FIG. 1A and FIG. 1B, battery cell 300 includes an upper layer 304, a lower layer 306, and an inner assembly 308 extending between upper layer 304 and lower layer 306. Collectively, upper layer 304, lower layer 306, and sealant 310 define an internal volume 302 that hermetically seals and contains inner assembly 308. Similar to inner assembly 108 of battery cell 100, inner assembly 308 of battery cell 300 includes one or more electrodes (not shown) to which conductive tabs may be electrically connected to permit electrical coupling to inner assembly 308 along with one or more corresponding electrolytes. For example, the cross-sectional view of FIG. 3 includes a first conductive tab 312a and a second conductive tab 312b. Battery cell 300 further includes a second conductive tab, which is not visible in the cross-sectional view.

Similar to battery cell 200 of FIG. 2, battery cell 300 includes supplemental layers 314. In contrast to supplemental layers 214 of battery cell 200, which provided additional resiliency and improved sealing of battery cell 200, supplemental layers 314 are intended to provide improved fire resistance. More specifically, supplemental layers 314 are shaped to define a void 316 adjacent internal volume 302. As shown in FIG. 3, for example, void 316 may be positioned adjacent to and partially defined by upper layer 304.

In another example implementation, a void may be defined within and between layers of the supplemental layers external a layer or layers directly surrounding inner assembly 108. So, for example, with reference to FIG. 2, one or more voids may be defined between first thermoplastic layer 216 and metallic layer 218 or between metallic layer 218 and second thermoplastic layer 220. Among other things, such an arrangement permits the internal battery cell and supplemental layers with voids to be manufactured separately, e.g., for inventory control and case of manufacturing, to permit the use of manufacturing methods for the supplemental layers that may be incompatible with the internal battery cell, and other similar purposes.

In the illustrated implementation, void 316 contains a fire suppressant 318 (e.g., a dry chemical fire suppressant) or similar fire-preventative substance (e.g., a flame retardant) intended to inhibit oxygen/moisture from reaching inner assembly 308 and/or endothermic reactants intended to absorb thermal energy produced by inner assembly 308. So, in the event inner assembly 308 overheats (e.g., due to thermal runaway or shorting) and causes upper layer 304 to melt, fire suppressant 318 will be released into internal volume 102, inhibiting or fully preventing ignition of battery cell 300 and substantially reducing the likelihood that damage to and failure of battery cell 300 will spread to adjacent battery cells or to the battery or equipment within which battery cell 300 is installed.

Fire suppressant 318 is intended as just one non-limiting example of a material that may be disposed within void 316 for purposes of providing enhanced safety-related functionality of battery cell 300. For example, instead of fire suppressant 318 or a flame retardant, void 316 may contain a self-sealing compound or polymer to protect against puncturing of internal volume 102. More generally, void 316 may be used to contain any liquid, semi-solid, or solid substance intended to provide additional resiliency, failure protection, or other similar features to battery cell 300.

While battery cell 300 is included to specifically illustrate the concept of supplemental layers 314 being used to define a functional void, such supplemental layers may be combined with the supplemental layers illustrates in FIG. 2 to provide both functional voids and improved resiliency/performance characteristics. Also, while battery cell 300 is shown as including a single void 316 disposed adjacent upper layer 304, other implementations of this disclosure may be configured to include a void positioned at other locations of battery cell 300, including multiple voids distributed about battery cell 300. In one particular example, a second void and related materials disposed therein, may be defined adjacent the lower layer 306 (or whatever other supplemental layers are positioned over lower layer 306).

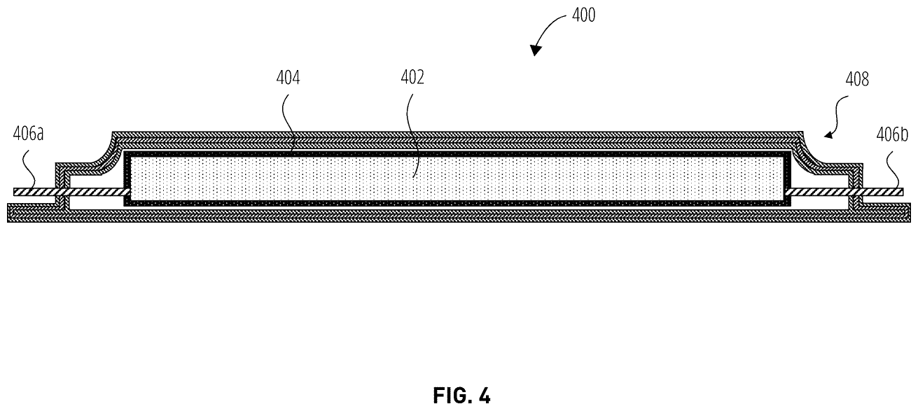

FIG. 4 is a cross sectional view of a fourth battery cell 400 according to this disclosure. In contrast to the previously disclosed battery cells, battery cell 400 relies primarily on a coating to provide resiliency, such as heat and mechanical resistance. More specifically, battery cell 400 includes an inner assembly 402 that is encapsulated within a coating layer 404. Coating layer 404 creates a hermetic seal around inner assembly 402 and around each of a first conductive tab 406a and a second conductive tab 406b electrically coupled to and extending from inner assembly 402. As shown, battery cell 400 further includes supplemental layers 408. For example, supplemental layers 408 may be substantially similar to supplemental layers 214 described above in the context of battery cell 200 of FIG. 2 and/or supplemental layers 314 of battery cell 300.

In general, coating layer 404 is applied directly to an exterior surface of inner assembly 402 and is formed using a coating material that permits expansion and contraction of inner assembly 402 without cracking or splitting of coating layer 404. The specific technique used to apply coating layer 404 will depend on the particular coating material used; however, in at least certain implementations, coating layer 404 may be formed from parylene or a similar polymer applied to inner assembly 402 by vapor deposition. In other implementations, coating layer 404 may be formed from a thermoplastic (e.g., nylon, thermoplastic polyurethane) and applied using a dip coating process. This disclosure also contemplates application of coating layers by other processes including, but not limited to, overmolding, thermal spray coating, and other coating methodologies.

FIG. 4 generally illustrates supplemental layers 408 as further encapsulating inner assembly 402 with each of first conductive tab 406a and second conductive tab 406b extending through supplemental layers 408. As previously discussed in the context of previous implementations including supplemental layers, supplemental layers 408 may generally be used to provide additional enhancements, structural integrity, safety features, etc., to battery cell 400. Supplemental layers 408 may also include or define functional voids, e.g., for containing fire suppressants, flame retardants, puncture resistant materials, or other functional materials.

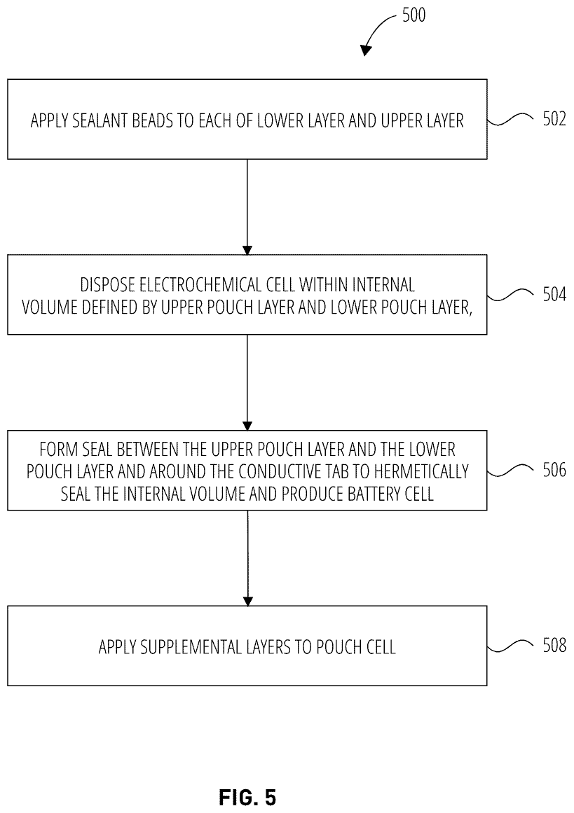

FIG. 5 illustrates an example method 500 for manufacturing a battery cell. Although the example method 500 depicts a particular sequence of operations, the sequence may be altered without departing from the scope of the present disclosure. For example, some of the operations depicted may be performed in parallel or in a different sequence that does not materially affect the outcome of method 500.

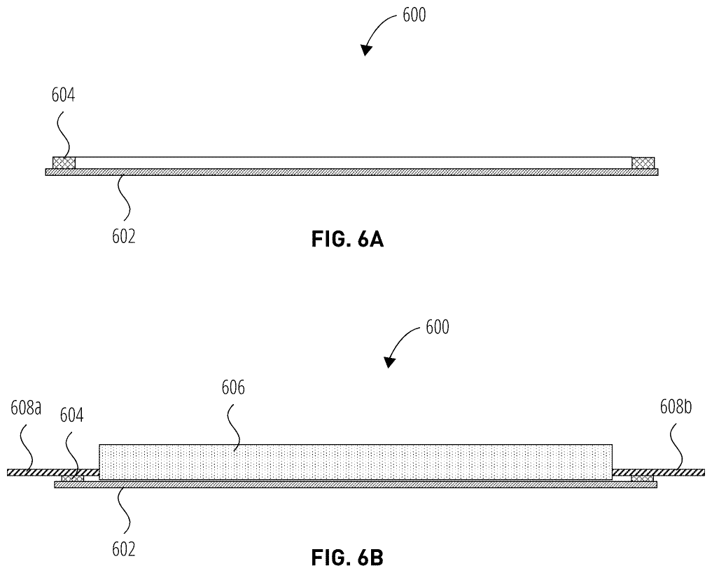

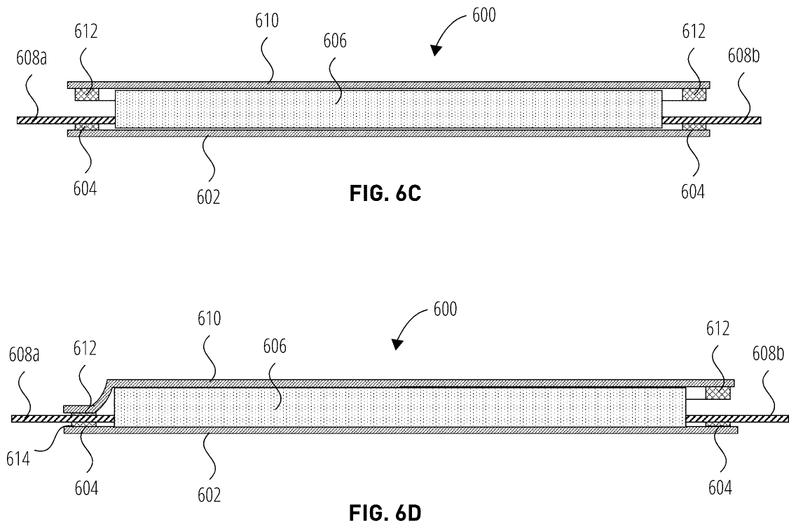

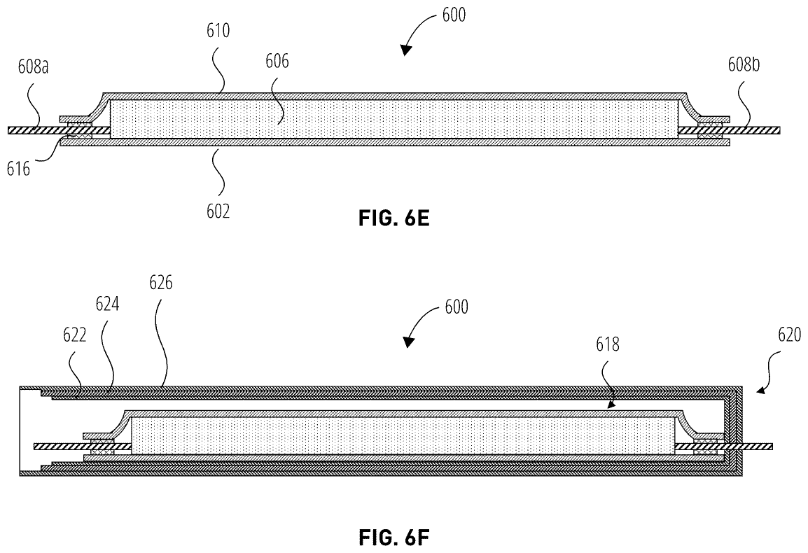

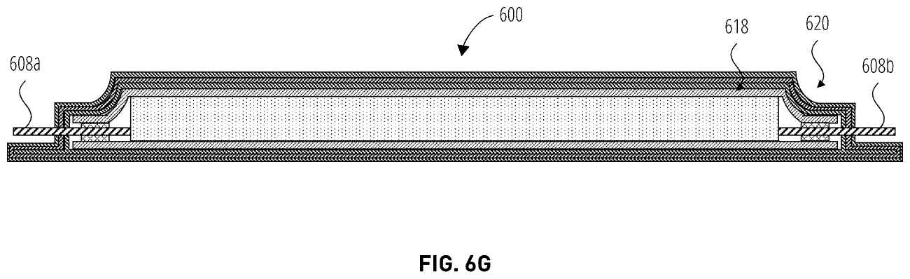

Method 500 is described with non-limiting reference to an example battery cell 600, which includes various features consistent with battery cells previously discussed in this disclosure. More specifically, FIG. 6A to FIG. 6G generally illustrate an example manufacturing method for a battery cell with the figures illustrating the battery cell in progressing stages of assembly.

For context, FIG. 6G illustrates a battery cell 600 similar to battery cell 200 of FIG. 2 and includes an inner cell assembly 620 contained within a secondary pouch formed from supplemental layers 622. FIG. 6E illustrates inner cell assembly 620 in further detail. More specifically, inner cell assembly 620 generally includes an upper layer 610, a lower layer 602, and a seal 618 defining an internal volume of the inner cell assembly 620. Inner cell assembly 620 further includes an inner assembly 606 disposed within the inner volume. A first conductive tab 608a and a second conductive tab 608b are electrically coupled to inner assembly 606 (e.g., to respective electrodes of inner assembly 606) and extend through seal 618. Seal 618 is generally formed such that the inner volume of inner cell assembly 620 is hermetically sealed, including hermetically sealing around first conductive tab 608a and second conductive tab 608b.

As described below in further detail, battery cell 600 further includes applying supplemental layers 622 to inner cell assembly 620 to form battery cell 600. However, in certain implementations, inner cell assembly 620 may be considered a complete battery cell, e.g., similar to battery cell 100 of FIG. 1A and FIG. 1B.

Referring now to method 500 of FIG. 5, method 500 begins at step 502 with applying sealant beads to each of a lower pouch layer and an upper pouch layer.

By way of example, FIG. 6A illustrates an initial assembly step of battery cell 600 following application of a first sealant bead 604 to lower layer 602. Although not shown in FIG. 6A, a second sealant bead 612 may be similarly applied to upper layer 610. For example, FIG. 6C illustrates a stage in assembling battery cell 600 prior to sealing the inner volume containing inner assembly 606. As shown in FIG. 6C, upper layer 610 includes a second sealant bead 612 that generally matches with first sealant bead 604 such that when upper layer 610 is stacked onto lower layer 602, first sealant bead 604 aligns with second sealant bead 612.

In certain implementations, either of first sealant bead 604 and second sealant bead 612 may be preformed “frames” that are subsequently disposed onto and optionally coupled to their respective pouch layer. In other implementations, the sealant beads may be formed or deposited onto their respective layers. For example, the sealant beads may be disposed onto their respective layers by extrusion, 3D printing (or other additive manufacturing technique), hot rolling, or spraying.

In certain implementations, the sealant beads may be at least partially coupled to their respective layers. For example, a preformed sealant bead may be adhered to a layer using an adhesive or by heating/partially melting the sealant bead and pressing the sealant bead onto the layer. In still other implementations, the layers and sealant beads may be coupled to each other as part of the general sealing process described below (e.g., step 506). In such implementations lower layer 602, first sealant bead 604, inner assembly 606, upper layer 610, and second sealant bead 612 may be stacked or otherwise laid up and subsequently pressed and heated to simultaneously fuse the components together.

At step 504, method 500 includes disposing an electrochemical assembly within an internal volume defined by upper pouch layer and lower pouch layer.

Referring to FIG. 6B, inner assembly 606 is shown as being positioned within the bounds of first sealant bead 604 of lower layer 602 with first conductive tab 608a and second conductive tab 608b extending across first sealant bead 604.

After disposing inner assembly 606 relative to lower layer 602, upper layer 610 may be positioned above or placed onto lower layer 602 with first sealant bead 604 and second sealant bead 612 aligned and, optionally abutting. As shown in in FIG. 6C and FIG. 6D, when first sealant bead 604 is aligned with and abutting second sealant bead 612, the sealant beads, lower layer 602, and upper layer 610 collectively define an inner volume containing inner assembly 606 with any conductive tabs for facilitating electrical connection with inner assembly 606 extending outside of the internal volume.

At step 506, method 500 includes hermetically sealing the internal volume. In general, the process of hermetically sealing the internal volume includes fusing or otherwise coupling first sealant bead 604 with second sealant bead 612 to form a seal 618 (shown in FIG. 6E) that also extends around any conductive tabs extending from inner assembly 606.

In implementations in which first sealant bead 604 and second sealant bead 612 are formed from thermoplastic or similar materials that can be melted and fused together, the process of hermetically sealing the internal volume may generally include heating each of the sealant beads while applying compression to cause the sealant beads to join together. Various methods of heating the sealant beads may be employed including any suitable thermal (e.g., hot plate, infrared, laser welding, general contact with a thermal conductor), mechanical (e.g., vibration or ultrasonic welding), electromagnetic (e.g., resistance, induction, or microwave welding), or chemical (e.g., solvent welding or using an adhesive) technique.

In at least certain implementations, sealing the battery cell may involve partially bonding/fusing the sealant beads, applying a vacuum to the partially sealed battery cell to evacuate the inner volume, and then completing the bonding/fusing of the sealant beads to fully seal the inner volume of the battery cell. For example, FIG. 6D illustrates battery cell 600 with first sealant bead 604 and second sealant bead 614 partially bonded/scaled. More specifically, a first portion of first sealant bead 604 and second sealant bead 614 is shown as forming partial seal 616 about first conductive tab 608a. However, a second portion of first sealant bead 604 and second sealant bead 614 is shown a still being unsealed around second conductive tab 608b. FIG. 6E illustrates a subsequent step in which first sealant bead 604 and second sealant bead 614 are fully joined to form seal 618, which extends and seals around second conductive tab 608b. As previously noted, in certain implementations, the process of completing seal 618 may be performed under vacuum to evacuate the inner volume of battery cell.

This disclosure contemplates that forming seal 618 may include applying multiple techniques for bonding/fusing the sealant beads and/or may include applying a given bonding/fusing technique non-uniformly about the sealant beads. For example, the conductive tabs (e.g., first conductive tab 608a and second conductive tab 608b) are generally formed using a metallic material and, as a result, may have high thermal conductivity. So, to the extent bonding/fusing of the sealant beads relies on melting the sealant beads (e.g., due to application of direct heat, friction, exothermic reactions, etc.), first conductive tab 608a and second conductive tab 608b may conduct heat away from the interface of the sealant beads, resulting in a less reliable or less complete seal. To address this issue, forming seal 618 may include any of applying a more thorough fusing bonding technique (e.g., by applying greater heat and/or for a longer duration) in certain areas of the battery cell, such as around first conductive tab 608a and second conductive tab 608b. As another alternative, a secondary sealing process may be applied. So, for example, an initial mechanical (e.g., ultrasonic or vibration welding) operation may be followed by a secondary thermal welding operation (e.g., a laser or infrared welding operation) targeting the specific areas.

At step 508, method 500 includes optionally apply supplemental layers to the pouch cell. For example, while in certain implementations the assembly illustrated in FIG. 6E may be considered a completed battery cell, in other embodiments the assembly may instead be considered an inner cell assembly 620 to which supplemental layers may be applied.

Referring to FIG. 6F, for example, inner cell assembly 620 may be disposed within one or more supplemental layers 622, e.g., in the form of a secondary pouch. As shown in FIG. 6G, supplemental layers 622 may be subsequently sealed around inner cell assembly 620 using any suitable technique to form a final battery cell 600.

This disclosure contemplates that supplemental layers 622 may be other forms and applied in other ways other than as a secondary pouch. In one alternative implementation, supplemental layers 622 may be in the form of sheets that are applied (either individually or in combination) to inner cell assembly 620. For example, supplemental layers 622 may be in the form of sheets that are disposed on opposite sides of inner cell assembly 620 and then sealed around inner cell assembly 620, such as by a vacuum or thermal sealing process. As shown in FIG. 6G, supplemental layers 622 are generally attached such that first conductive tab 608a and second conductive tab 608b remain exposed to facilitate electrical connection of battery cell 600.

Although the specific layers included in supplemental layers 622 may vary in implementations of this disclosure, FIG. 6E illustrates one implementation in which supplemental layers 622 include three distinct layers. First, supplemental layers 622 include a first thermoplastic layer 624 adjacent inner cell assembly 620. Among other things, first thermoplastic layer 624 may facilitate bonding of supplemental layers 622 to inner cell assembly 620 and/or provide an additional seal around inner cell assembly 620. In one specific implementation, first thermoplastic layer 624 may be formed from polypropylene.

Supplemental layers 622 further include a metallic layer 626 to provide structural integrity, shape, and mechanical toughness to battery cell 600. By way of non-limiting example, metallic layer 626 may be formed from a thin layer of aluminum or other metal. However, in other implementations metallic layer 626 may be substituted with a rigid or reinforced thermoplastic with comparable properties.

Finally, supplemental layers 622 is further illustrates as including a second thermoplastic layer 628 that generally forms the exterior of battery cell 600. Again, the specific material of second thermoplastic layer 628 may vary based on the specific application; however, in at least certain implementations, second thermoplastic layer 628 may be formed from a material selected to form a vapor barrier around battery cell 600, to provide mechanical resistance, to improve structural integrity of battery cell 600, and/or to provide other similar benefits. In one example implementation, second thermoplastic layer 628 may be formed from nylon.

The foregoing example of supplemental layers 622 is provided strictly as an illustration of one implementation of battery cells according to this disclosure. Accordingly, implementations of this disclosure including supplemental layers are not limited to having an arrangement of a metallic layer between two thermoplastic layers or any specific materials noted above. Rather, the foregoing example of supplemental layers 622 is intended to provide one example of an arrangement of layers that provides certain benefits (e.g., bonding to inner cell assembly 620, improved mechanical properties, a vapor barrier, etc.). Stated differently, this disclosure contemplates that other arrangements of supplemental layers and other supplemental layer materials may be used to improve various other characteristics and properties of battery cells.

While FIG. 6G illustrates supplemental layers 622 as being flush with or otherwise formed to inner cell assembly 620, in other implementations, supplemental layers 622 may be coupled to inner cell assembly 620 such that one or more voids are present between inner cell assembly 620 and supplemental layers 622 or between different layers of supplemental layers 622. As previously discussed in the context of FIG. 3, such voids may be used to contain materials for providing improved safety or other benefits to battery cell 600. For example, as noted in the context of FIG. 3, the void may contain a fire retardant or reactants for an endothermic reaction, each of which may provide protection against runaway heating or fire in the case of battery cell 600 becoming damaged or faulty.

While FIG. 6F and FIG. 6G illustrate supplemental layers 622 as being arranged and subsequent to sealing of inner cell assembly 620, this disclosure contemplates that sealing inner cell assembly 620 and attaching supplemental layers 622 to inner cell assembly 620 may occur simultaneously. For example, the process (or processes) for heating or otherwise fusing/bonding first sealant bead 604 to second sealant bead 614 may also bond supplemental layers 622 to inner cell assembly 620 and layers of supplemental layers 622 to each other.

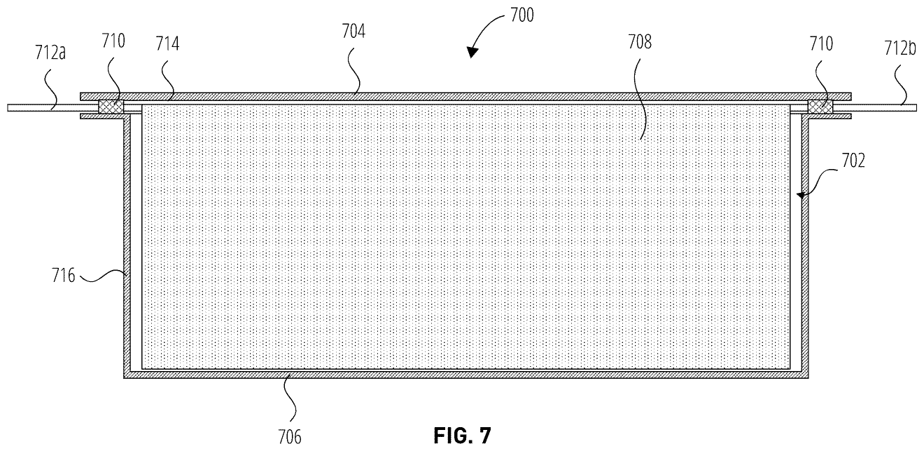

FIG. 7 is a cross-sectional view of a battery cell 700 according to this disclosure. Battery cell 700 includes an upper layer 704, a lower layer 706, and a sealant 710 extending between upper layer 704 and lower layer 706. Collectively, upper layer 704, lower layer 706, and sealant 710 define an internal volume 702. When battery cell 700 is fully assembled, internal volume 702 is hermetically sealed and contains an inner assembly 708.

As in previous implementations described in this disclosure, inner assembly 708 generally includes multiple electrodes to which conductive tabs or similar structures are electrically coupled to permit electrical connection to inner assembly 708. Battery cell 700, for example, includes each of a first conductive tab 712a and a second conductive tab 712b, each of which is electrically connected to a respective electrode of inner assembly 708. As shown, first conductive tab 712a and second conductive tab 712b extend from opposite ends of battery cell 700; however, in other implementations, first conductive tab 712a and second conductive tab 712b may extend from the same side of battery cell 700, from perpendicular sides of battery cell 700, or otherwise as dictated by the assembly within which battery cell 700 is incorporated. Regardless, as in previous implementations, when fully assembled, each of first conductive tab 712a and second conductive tab 712b extends through sealant 710 such that sealant 710 extends and hermetically seals around each of first conductive tab 712a and second conductive tab 712b.

The implementation of FIG. 7 is intended to illustrate an example implementation of this disclosure including a preformed shell 716. While not limited to such applications, at least partially preforming the exterior structure of battery cells according to this disclosure may be particularly useful for manufacturing and assembly of battery cells having relatively thick or otherwise large-format electrochemical cell, as illustrated by the general differing in thickness between inner assembly 708 of battery cell 700 and the electrochemical cells illustrated in the preceding figures.

In one example implementation, preformed shell 716 may be preformed using a suitable molding or forming technique for the material used for preformed shell 716. For example, depending on the material used to form preformed shell 716, preformed shell 716 may be formed using one of compression, injection, or transfer molding. Preformed shell 716 may also be formed using an additive manufacturing technique including, but not limited to 3-D printing. Preformed shell 716 may also be formed using more than one material, such as by a co- or overmolding process. As described above in the context of FIG. 5 and FIGS. 6A-6G, sealant 710 may be formed by fusing two sealant beads. Accordingly, manufacturing and forming of preformed shell 716 may also include applying a sealant bead around a perimeter of preformed shell 716 that aligns with a corresponding sealant bead disposed on upper layer 704.

With the foregoing in mind, manufacturing of battery cell 700 may be generally similar to manufacturing of other battery cells of this disclosure. For example, assembly of battery cell 700 may include disposing inner assembly 708 in preformed shell 716 such that first conductive tab 712a and second conductive tab 712b extend outwardly from preformed shell 716. Subsequently, upper layer 704 may be disposed on an open side of preformed shell 716, aligning a sealant bead disposed on upper inner surface 714 of upper layer 704 with a sealant bead extending around the perimeter of preformed shell 716 such that first conductive tab 712a and second conductive tab 712b are sandwiched between the sealant beads. Heat may then be applied (optionally with pressure) to melt the sealant beads around first conductive tab 712a and second conductive tab 712b, hermetically scaling internal volume 702, including around the conductive tabs. During scaling, a vacuum may also be applied to internal volume 702 to evacuate internal volume 702.

As in previous implementations, battery cell 700 may include supplemental layers external one or both of preformed shell 716 and upper layer 704. Such supplemental layers may also be configured to include voids or pockets within which fire suppressants or other materials may be disposed.

Features described above as well as those claimed below may be combined in various ways without departing from the scope hereof. The previous examples illustrate some possible, non-limiting combinations. It should thus be noted that the matter contained in the above description or shown in the accompanying drawings should be interpreted as illustrative and not in a limiting sense. The above-described embodiments should be considered as examples of the present disclosure, rather than as limiting its scope. In addition to the foregoing embodiments of inventions, review of the detailed description and accompanying drawings will show that there are other embodiments of such inventions. Accordingly, many combinations, permutations, variations, and modifications of the foregoing embodiments not set forth explicitly herein will nevertheless fall within the scope of this disclosure. The following claims are intended to cover generic and specific features described herein, as well as all statements of the scope of the present methods, systems, and devices, which, as a matter of language, might be said to fall there between.

What is claimed is:

1. A battery comprising:
a cell comprising a first electrode layer, a second electrode layer, and an electrolyte layer;
a pouch having an internal volume, the pouch comprising:
a first layer including a first heat-resistant material and forming a first inner surface of the pouch;
a second layer including a second heat-resistant material and forming a second inner surface of the pouch opposite the first inner surface; and
a sealant disposed between the first layer and the second layer; and
a conductive tab extending through the sealant and electrically coupled to the first electrode layer,
wherein the sealant hermetically seals against each of the first layer of the pouch, the second layer of the pouch, and the conductive tab, thereby hermetically sealing the cell within the internal volume.

2. The battery of claim 1, wherein at least one of the first heat-resistant material and the second heat-resistant material is a polyimide polymer.

3. The battery of claim 1, wherein the sealant is disposed on the first layer of the pouch and shaped to accommodate the cell within the sealant.

4. The battery of claim 1, wherein the sealant includes a thermoplastic.

5. The battery of claim 1, wherein the sealant is disposed between the first layer and the second layer in a shape corresponding to a shape of the cell.

6. The battery of claim 1, wherein at least a portion of one of the first layer or the second layer conforms around the electrode and the electrolyte.

7. The battery of claim 1, wherein the pouch further includes at least one of a first thermoplastic layer outwardly adjacent the first layer and the second layer, a metallic layer outwardly adjacent the first thermoplastic layer, or a second thermoplastic layer outwardly adjacent the metallic layer.

8. The battery of claim 1, wherein the pouch is contained within a secondary pouch and a void is defined between the pouch and the secondary pouch.

9. The battery of claim 8, wherein the secondary pouch includes a vapor barrier layer.

10. The battery of claim 8, further comprising a flame retardant disposed within the void.

11. The battery of claim 8, wherein the conductive tab further extends through the secondary pouch.

12. The battery of claim 1, wherein the first electrode layer is an anode and the second electrode layer is a cathode.

13. A battery cell comprising:
a first electrode;
a second electrode;
an electrolyte;
a conductive tab electrically coupled to the first electrode; and
a coating layer, wherein the coating layer encapsulates the first electrode, the second electrode, and the electrolyte, the conductive tab extending through the coating layer, and the coating layer forming a hermetic seal around the first electrode, the second electrode, and the electrolyte and about the conductive tab.

14. The battery cell of claim 13, wherein the coating layer includes a thermoplastic.

15. The battery cell of claim 13, wherein the coating layer is formed by dip coating.

16. The battery cell of claim 13, wherein the coating layer is formed by vapor deposition.

17. The battery cell of claim 13 further comprising a plurality of cell structures each comprising an anode, a cathode, and a solid electrolyte operably positioned therebetween.

18. A method for manufacturing a battery cell, the method comprising:
disposing an electrode and an electrolyte within an internal volume defined by a first pouch layer, a second pouch layer, and a sealant layer, wherein a conductive tab electrically coupled to extend out of the internal volume; and
forming a seal between the first pouch layer and the second pouch layer and around the conductive tab by heating the sealant layer to a melting point to hermetically seal the internal volume,
wherein the first pouch layer includes a first heat-resistant material and the second pouch layer includes a second heat-resistant material.

19. The method of claim 18, wherein forming the seal includes fusing a first sealant bead coupled to and extending from the first pouch layer to a second sealant bead coupled to and extending from the second pouch layer.

20. The method of claim 19, wherein forming the seal includes preheating at least one of the first sealant bead, the second sealant bead, and the conductive tab.
